(19) United States
(12) Patent Application Publication
(10) Pub. No.: US 2010/0071993 A2
(43) Pub. Date: Mar. 25, 2010

(54) SAFETY TETHER ANCHOR

(75) Inventors: John Wydner, Danville, AL (US); Patrick Tourville, Appleton, WI (US)

Correspondence Address: BRADLEY ARANT BOULT CUMMINGS LLP, 200 CLINTON AVE. WEST, SUITE 900, HUNTSVILLE, AL, 35801, UNITED STATES, 256-517-5100, 256-517-5200

(73) Assignee: Hunter Safety System, Inc., Danville, AL (US)

(21) Appl. No.: 12/237,205

(22) Filed: Sep. 24, 2008

Related U.S. Application Data
(60) Provisional application No. 60/995,142, filed on Sep. 25, 2007.

(51) Int. Cl. A62B 35/00; E04G 3/24

(52) U.S. Cl. 182/3; 182/187

(57) ABSTRACT

The present invention relates to a safety tether anchor. The safety tether anchor includes a base for mounting to a tree or other support. The base is securely connected to the support. The safety tether anchor includes a pig tail for attaching a safety harness tether to a support arm of the safety tether anchor. The pig tail can be slidably connected to the support arm so the pig tail can move inwardly or outwardly relative to the vertical support. A pivot arm can also be connected to the support arm, and the pivot arm can be used to hold a wide variety of items.

This invention claims priority to U.S. Provisional Patent Application No. 60/995,142, which was filed on Sep. 25, 2007, which is incorporated by reference herein.

### BACKGROUND OF THE INVENTION

A. Field of the Invention

The present invention relates to a safety tether anchor for securing an individual elevated above the ground. The individual secures one end of a safety tether to himself such as with a safety harness, and secures the other end of the safety tether to the safety tether anchor.

B. Description of the Related Art

Tree stands are used by hunters to elevate the hunter above the ground. This can give the hunter a wider range of vision, and it also provides a stealth element because many game animals will not notice a hunter in a tree as readily as they will notice a hunter on the ground. A wide variety of tree stands are available for various applications. Safety is of paramount importance when hunting. Every year accidents occur while hunters are on tree stands. Some hunters fall asleep and others simply lose their balance or misstep. Regardless, a fall can result in serious injury or death.

Most tree stands recommend the use of a safety harness to improve safety for the hunter while in the tree stand. Generally, the safety harness is worn by the hunter and one end of a tether is connected to the safety harness. The other end of the tether is then secured to the tree so the safety harness and tether prevent the hunter from falling to the ground. The shorter the tether, the shorter the distance the hunter falls before the fall is arrested. The longer the tether, the longer the distance the hunter falls and the greater the shock when the hunter reaches the end of the tether. Various tether designs are available which can help minimize the shock when the tether catches.

Several varieties of tree stands and safety devices have been developed. These include various devices and techniques for securing one end of the tether to the tree and even alternative methods to prevent a fall from a tree stand. Additionally, a hunter will often desire ready access to various items or accessories while in a tree stand, such as a bow or a rifle. A wide variety of other items or accessories may also be desired, including an umbrella, a light, a pulley, a rifle support, a camera holder or even a cup holder. The hunter generally desires these items to be available but still not be in the way when not in use.

Although the hunter may desire access to several different items in a tree stand, the hunter generally doesn't want to drag too much weight up and down into the tree stand or make repeated trips. Devices which are smaller, lighter and serve more than one function can minimize the effort a hunter expends when preparing for a hunt in a tree stand.

Tree stands or other supports can be used by people other than hunters. For example, a camera operator can use a tree stand to film a hunter in a separate tree stand. Also, workers of various sorts may need to use a tree stand or other support structure for working above the ground. Various sorts of support structures or tree stands can also be used for surveillance, bird watching, or other viewing activities. Securing a person to a fixed structure when the person is above the ground is a common and effective practice used in a wide variety of applications.

### SUMMARY OF THE INVENTION

The present invention attaches to a tree or other support and serves as an anchor for a safety harness tether. The tether is attached to the safety tether anchors for example through a pig tail, and the safety tether is able to move along the safety tether anchor. The pig tail moves inwardly and outwardly relative to the support which allows an increased range of motion for the user in the tree stand or other support.

### BRIEF DESCRIPTION OF THE DRAWINGS

FIG. 1 is a side view of one embodiment of the present invention.

FIG. 2 is a side view of an alternative embodiment of the present invention.

FIG. 3 is a side view of another embodiment of the present invention.

FIG. 4 is a partial cut away perspective view of an additional embodiment of the present invention.

FIG. 5 is a perspective view of a portion of one embodiment of the present invention.

FIG. 6 is a view of one embodiment of the current invention in use.

### DETAILED DESCRIPTION

While the invention will be described in connection with several embodiments, it will be understood that it is not intended to limit the invention to those embodiments. On the contrary, it is intended to cover all alternatives, modifications and equivalents as may be included within the spirit and scope of the invention as defined by the appended claims. In this detailed description, reference will generally be made to the use of the safety tether anchor with a tree stand. It is to be understood that the safety tether anchor can also be used with other supports for securing a person above the ground. In this discussion reference will be also be made to securing the tether to a tree, but it is understood that the tether can also be secured to almost any support which can serve as an attachment point for the tether.

Many hunters use tree stands while hunting. The tree stand provides a support platform for the hunter at some elevation above the ground. Most tree stand manufacturers recommend that a user wear a safety harness with a tether whenever the user is in the tree stand at any significant elevation above the ground. Many safety harnesses have a tether attachment point positioned on the users back, but some safety harnesses have front mounted tether attachment points. Generally, the tether is secured to the tree but it can also be secured to any anchor point available, such as a telephone pole for a workman. Preferably the tether is secured above the user because this minimizes the distance of a fall. When someone in a tree stand falls, they fall the distance from where they stand to where they hang supported by the tether. If the tether is anchored above the user, the fall is shorter than if the tether is anchored below the user. Generally, a shorter fall is preferred because a longer fall produces a greater shock and can also leave the user suspended further from the tree stand.

When a hunter is using a tree stands they often desire to move about somewhat on the tree stand. This movement can be limited by the tether length. A shorter tether provides for a shorter fall for the hunter, but because the hunter is secured to the tree by the tether it allows less movement on the tree stand. In fact, sometimes the tether can be so short that the hunter will not be able to sit in a tree stand facing the tree without the tether pulling the hunter into a hunched over or leaning forward position.

Short tethers can interfere with a hunt. If the hunter is standing in a tree stand and the game he is hunting passes behind him and behind the tree on which the tree stand is mounted, the hunter would prefer to be able to gradually turn towards the tree and follow the game animal in his line of sight as the game animal passes behind him. Often with a short tether the hunter is not able to do this, and as he turns he comes to a point where the tether catches and won't allow him to turn any further. At this point the hunter must turn around the other way, taking his eye off the game and regaining vision of the game animal as he turns from the opposite direction, similar to the way an owl turns its head when watching something pass behind it. When the hunter takes his eye off the game animal, he can not tell if the animal sees him in the tree. Therefore, the hunter may move when the game animal is looking at the hunter without knowing that the game animal is watching. This can frighten the game animal away, so being able to turn all the way around toward the tree while still secured by the tether can improve the hunter's success.

Many tree stands are relatively small in area such that they are easier to pack, move, and mount and also less obvious while up in a tree. Because of this limited space, there is limited area for the hunter to store accessories which may be desirable while in the tree stand. Also, the hunter may have various tasks to perform while in the tree stand. This can include lifting or lowering various items, setting up camouflage, taking photographs, or eating lunch. Generally, hunters prefer equipment which is silent in operation because noise tends to frighten away game animals, or at least give away the position of the hunter. Any improvement which makes the hunter quieter is desirable.

### Base

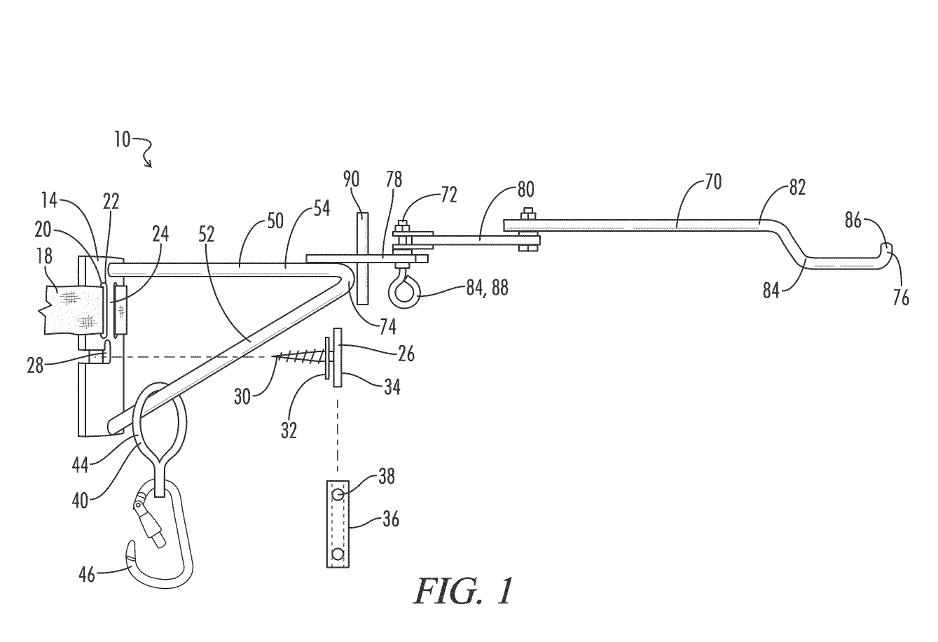

The current invention is a safety tether anchor 10 which can be used with a tree stand 12 while hunting, as seen in exemplary embodiments in FIGS. 1, 5 and 6. The safety tether anchor 10 can include a base 14 which is generally mounted or secured on a tree 16 or some other support. The base 14 can have an essentially vertical orientation such that the base is longer in the vertical direction than it is in the horizontal direction. The vertical orientation provides additional support when the base 14 is mounted on an essentially vertical support. The base 14 can have a variety of shapes. It can include three plates connected at angles such that the plates will approximate the curvature of a tree 16 of some diameter. The base 14 can also be a single flat plates a continuous curved surface, or even simply the edges of intersecting plates. The base 14 can include other shapes as appropriate. The base 14 can include teeth or sharp angles to help the base 14 securely attach to the tree 16. The base 14 can be made of metal or other materials with sufficient strength to support the safety tether anchor and a falling person.

In use the base 14 is secured to a tree 16. One way to secure the base 14 to the tree 16 is with the use of a strap 18. The strap 18 can be a ratchet strap which can be ratcheted into a tighter and tighter position around the tree 16, but the strap 18 can also be banding, or webbing with buckles, a line or ropes a chain or any of a variety of other devices which can wrap around the tree 16. The base 14 can include a strap notch 20 for receiving the strap 18. The strap notch 20 can be a single or a matched pair of elongated holes 22 in the base 14, which can also include a raised portion 24 between the elongated holes 22. The strap 18 is then received through the elongated holes 22 of the strap notch 20. However, the strap notch 20 can also assume a wide variety of different structures. For example, the strap notch 20 can be a pair of raised tabs which help keep the strap 18 from sliding above or below the tabs, or the strap notch 20 can be an indented area in the base 14 which tends to hold the strap 18 in a single position. It is even possible for the strap notch 20 to be an area with some sort of coating or texture which increases friction such that the strap 18 has less of a tendency to slide out of a particular area on the base 14. In use the strap 18 is received in the strap notch 20 and the strap 18 secures the base 14 to the tree 16 by passing around the tree 16.

The base 14 can be secured to the tree 16 in other ways, such as with a screw 26 and a screw receptacle 28. The screw 26 can have a tapered point 30 and a stop plate 32 at the end of the threaded portion of the screw 26. The screw 26 can also have a T-handle 34 which provides additional leverage for twisting the screw 26 in and out of the tree 16. The screw 26 can also have a wing nut, a hex head or other type of head for twisting in and out of the tree 16. A screw accessory 36 can be included which can serve as a cheater bar to aid in twisting the screw 26 in and out of the tree 16. The screw accessory 36 can have a hollow end which is inserted over one end of the T-handle 34 to provide additional leverage for twisting the screw 26. The screw accessory 36 can also have one or more holes 38 large enough to receive the T-handle 34 and allow more varied access for manipulating the screw 26.

The screw receptacle 28 in the base 14 receives the screw 26. The screw receptacle 28 can be an inverted J-slot so the base 18 can slide sideways over the screw and then move downwards such that the screw 26 comes to rest in the notch at the end of the J-slot. This configuration allows gravity to pull the base 14 downwards which helps hold the base 14 in position on the screw 26. The screw receptacle 28 could also be a simple hole large enough to receive the screw 26, or it could be a straight slot, or it could be a variety of other shapes. With certain types of screw receptacles 28, the screw 26 can be twisted in to the tree 16 before the base 14 is mounted on the tree 16. The screw 26 is received in the screw receptacle 28 and the screw 26 can be twisted into the tree 16 until the stop plate 32 abuts the base 14. The pressure of the stop plate 32 on the base 14 provides some friction which tends to hold the base 14 against the tree 16. The safety tether anchor 10 can be secured to the tree 16 by either a strap 18, a screw 26, a combination of one or more straps 18 and/or screws 26, or with other securing devices.

### Pig Tail

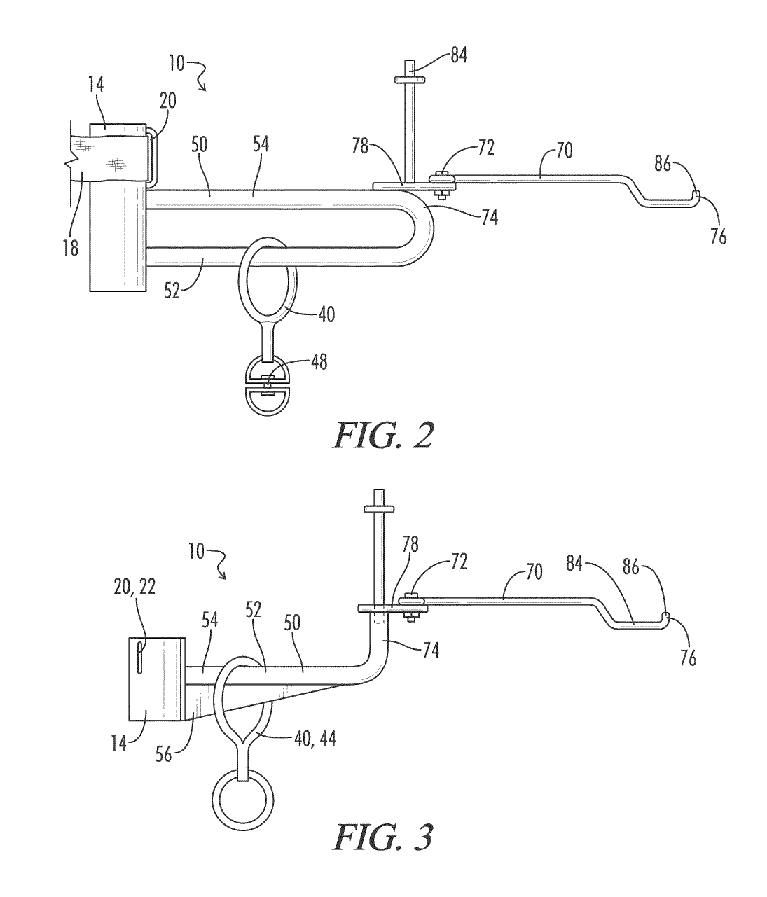

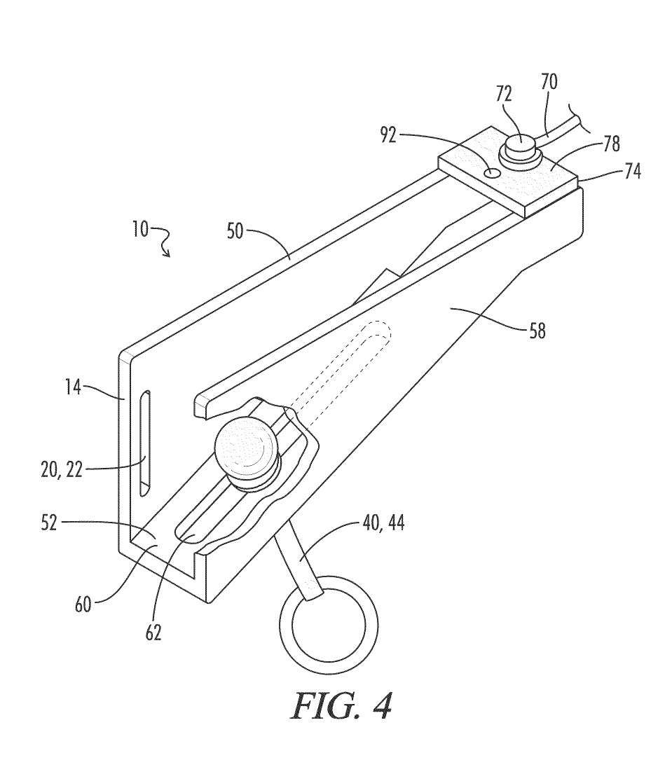

In some embodiments, a pig tail 40 is used to connect a tether 42 to the safety tether anchor 10. The pig tail 40 may be able to slide on the safety tether anchor 10, and it may be able to slide inwardly and outwardly from the base. The pigtail 40 can provide a quick, easy, secure way to connect the tether 42 to the safety tether anchor 10. The pig tail 40 can consist of a length of line 44 or rope which is secured about a portion of the safety tether anchor 10. The line 44 tends to be quiet as it slides on the safety anchor tether 10, and quiet operation is beneficial for a hunter. A carabineer 46 can be connected to the line 44 to provide for a quick and easy attachment for the tether 42. The pig tail 40 can also be a carabineer 46 connected directly to the safety anchor tether 10 without the line 40. The pigtail 40 can also be a ring as seen in FIG. 2, or it can be a bolt or knot secured in a notch as shown in FIG. 4. The pigtail 40 can also be a buckle or even a bracket with wheels or bearings. The pigtail 40 facilitates connecting a tether 42 to the safety tether anchor. The pigtail 40 is strong enough to support a falling individual.

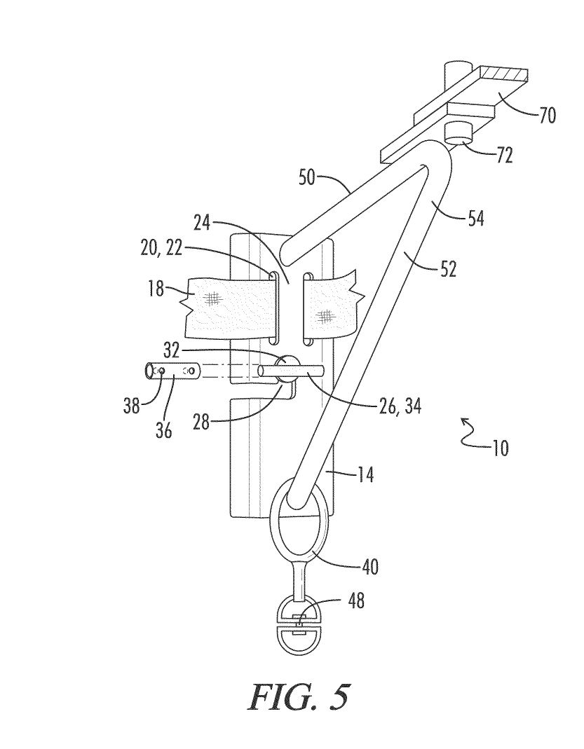

The pig tail 40 may be able to twist such that as the hunter 11 moves about on the tree stand 12, he is not restricted by the twisting motion of the tether 42. A twisting motion can be accomplished in many ways. A knot can rotate in a notch, as shown in FIG. 4, or a swivel 48 can be used, as shown in FIGS. 2 and 5. A length of line 44 allows for some twisting, as seen in FIG. 1. There are many other structures which allow for at least some twisting.

### Support Arm

The safety tether anchor 10 also includes a support arm 50 which is connected to the base 14, as seen in FIGS. 1, 5, and 6. The support arm 50 extends away from the base 14, and has to be strong enough to support a person when suspended from the support arm 50. The support arm 50 can be made of metal or other materials with sufficient strength. The support arm 50 can be rigidly connected to the base 14, or it can also be pivotally connected to the base 14 such that the support arm 50 can move from side to side. The pig tail 40 is connected to the support arm 50 and can be connected in a slidable manner such that the pig tail 40 slides along the support arm 50. The support arm 50 can include a slide bracket 52 within the support arms where the pig tail 40 is connected to the slide bracket 52. The pig tail 40 can move along the slide bracket 52, and this allows increased movement of the user or hunter 11.

The support arm 50 can bias the pig tail 40 towards the base 14. Angling the slide bracket 52 upwardly and outwardly from the base 14, as shown in FIGS. 1, 5, and 6, causes gravity to urge the pig tail 40 down the slide bracket 52 towards the base 14. Other devices and structures can be used to urge the pig tail 40 towards the base 14, such as elastic straps connected between the pig tail 40 and the base 14, or magnets on both the pig tail 40 and the base 14.

in embodiments where the support arm 50 urges the pig tail 40 towards the base 14, the safety tether anchor 10 provides a stronger, more secure anchor for the hunter's tether 42. This is because the weight of the hunter 11 in a fall is supported at the position of the pig tail 40. If the pig tail 40 is positioned away from the base 14, there is a large moment arm between the base and the position of the pig tail 40. This moment arm provides greater stress on the support arm 50. If the pig tail 40 is very near the base 14, there is a very small moment arm between the pig tail 40 and the base 14, and this reduces the stress on the support arm 50. Less stress on the support arm 50 results in a stronger attachment point for the tether 42. When at rest, a slide bracket 52 that angles upwardly and outwardly from the base 14 biases the pigtail 40 toward the base 14, which is the strongest position. Therefore, when a hunter 11 is resting and not pulling on the pigtail 40, the pigtail 40 is positioned in the most secure location.

The support arm 50 can have any of several different shapes. A few of those shapes are illustrated in this description. One example includes two tubes 54 which are joined together, one over the other, or alternatively, one tube 54 with a bend in it such that there is one tube 54 over the other, as depicted in FIGS. 1, 2, and 5. The lower tube 54 can be angled upwardly and outwardly from the base 14 as shown in FIGS. 1 and 5, or the lower tube 54 can be horizontal as shown in FIG. 2. The support arm 50 can include one single tube 54 which can be angled or straight, as shown in FIG. 3, and gussets 56 can be added to the tubes 54 to provide additional strength although gussets 56 are not required. The support arm 50 can also include a pair of vertical plates 58 with a notched plate 60 between the vertical plates 58, as shown in FIG. 4. The notched plate 60 includes a notch 62 which supports the pig tail 40. The angle of the notched plate 60 provides the force to urge the pig tail 40 towards the base 14. The base 14 shown in FIG. 4 merely consists of the edges of the vertical and notched plates 58 and 60.

The pigtail 40 slides along the slide bracket 52, and can slide inwardly and outwardly relative to the support and the base 14. The inward and outward sliding motion can be essentially straight in and out, as with the support arms 50 illustrated in FIGS. 2 and 3, or the inward and outward sliding motion can be accompanied with an upward and downward sliding motion, as with the support arms 50 illustrated in FIGS. 1, 4, 5, and 6. As a hunter 11 moves away from the tree 16, the pigtail 40 slides out along the slide bracket 52. This sliding motion allows the hunter 11 a wider range of motion. When the hunter 11 moves back in towards the tree 16, the pigtail 40 slides in on the slide bracket 52, so the hunter 11 can use a shorter tether 42 while still having a relatively large range of motion on the tree stand 12. The shorter tether 42 tends to provide for a shorter fall distance, which is usually safer.

### Pivot Arm

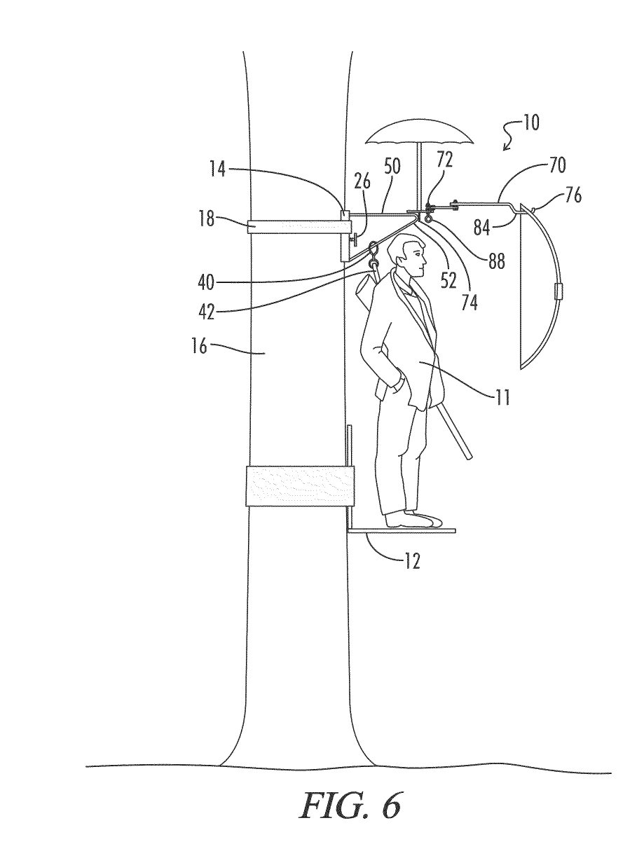

The safety tether anchor 10 can also include a pivot arm 70. The pivot arm 70 provides support for accessories when in a tree stand 12 as best seen with reference to FIGS. 1 and 6. The pivot arm 70 is not designed to support a falling individual, so it does not have to be as strong as the support arm 50. The pivot arm 70 can be pivotally connected to the support arm 50 at a pivot point 72, but it is also possible for the pivot arm 70 to be rigidly connected. The pivot point 72 can be at or near a support arm distal end 74. Connecting the pivot arm 70 to the support arm distal end 74 serves to maximize the distance between the tree 16 and the pivot arm distal end 76. Maximizing the distance between the tree 16 and the pivot arm distal end 76 serves to maximize the distance at which an accessory can be held out and away from the tree, and this can improve the utility and convenience for the hunter 11.

A tab 78 can be used at the pivot point 72. The tab 78 serves as a mount for the pivot point 72 and facilitates the connection between the support arm 50 and the pivot arm 70. The pivot point 72 can provide for pivoting the pivot arm 70 in a single plane or the pivot point 72 can provide for a more universal type pivot such that the pivot arm 70 can pivot in a wide variety of directions, including vertically, horizontally and any combination thereof. Pivoting in a single plane, including an essentially horizontal plane, can provide for fewer issues with an accessory gradually sliding down and out of an optimum location, so accessory storage may be more secure. Also, a pivot point 72 that pivots in a single plane may be less expensive easier to maintain, and stronger. A universal pivot point 72 allows for a wider variety of locations for holding an accessory.

If an accessory such as a bow or other item is stored on the pivot arm 70, it can be moved or pivoted out of the way of the hunter 11 when desired. The pivot arm 70 also allows the hunter 11 to move the bow or other item to a wide variety of positions to provide a way of keeping the bow at the most convenient position for the hunter 11. The pivot arm 70 can be comprised of a plurality of pivot arms including an inner pivot arm 80 and an outer pivot arm 82. Each successive section of the pivot arm 70 can be pivotally connected to the prior pivot arm section, with the inner pivot arm 80 being pivotally connected to the support arm 50. The use of a plurality of pivot arm sections allows for the pivot arm 70 to expand further away from the tree 16 while still allowing the entire safety tether anchor 10 to fold and compact into as small an area as possible. The pivot arm distal end 76 would be on the outer pivot arm 82.

The safety tether anchor 10 can include a plurality of attachment points 84. The pivot arm distal end 76 can include an attachment point 84 such as an upward bend 86, or an indentation with an upward bend 86. The upward bend 86 reduces the chance of a bow or other accessory slipping from the pivot arm 70, yet allows easy access when the hunter 11 wants to remove the accessory.

The pivot arm 70 can be designed to include a camera holder. The attachment point 84 at the pivot arm distal end 76 can be a camera holder which can include a multi-directional pivot such as a ball and socket pivot. An embodiment for use as a camera holder includes the outer pivot arm 82 being set to pivot through a vertical position. The outer pivot arm 82 can pivot in an essentially vertical plane or it can pivot in a more universal manner as long as it pivots through an essentially vertical position. The inner pivot arm 80 can pivot in something other than a horizontal plane, but in this embodiment the outer pivot arm 82 should pivot through a vertical position. In this embodiment the camera attachment at the pivot arm distal end 76 is supported from above, and it allows complete freedom of movement for a cameraman in the tree stand 12. The camera is mounted and supported from above which keeps the camera mount out of the way of the cameraman. This eliminates any need for leveling of the camera mount and allows for a wide range of motion of the camera unimpeded by the body of the cameraman.

### Accessories

A hunter 11 will often desire access to a variety of accessories while in a tree stand 12. These accessories should be held securely but yet be readily available when desired. The accessories can be held at attachment points 84 on the safety tether anchor 10, and these attachment points 84 can be positioned on the support arm 50, the pivot arm 70, the tab 78, or even the base 14. There can be a plurality of attachment points 84, and the attachment points 84 can take on a wide variety of shapes, functions and purposes.

Any combination of locations and attachment point shapes and functions can be utilized as desired. Some attachment points 84 can be used to hang items, and these attachment points 84 can include eye hooks 88, open hooks, threaded rods or recesses into which an attachment can be threaded, upward bends in an arm 86, clips, bags or pouches, hook and loop fasteners, magnets or any other device for hanging an item. There can also be attachment points 84 which are used to support items above the safety tether anchor 10. This can include a stand 90, such as an upward projecting rod or pipe. Sizing the rod to fit inside the pipe makes the stand 90 function. The accessory has either the rod or pipes and the stand 90 has the other component, so the accessory can be attached projecting above the safety tether anchor 10. Another attachment point 84 which could be used to support items above the safety tether anchor 10 includes a recess 92 as shown in FIG. 4, with continuing reference to FIGS. 1 and 6. A rod can be inserted or threaded into the recess 92. The recess 92 or stand 90 can be threaded to make for a more secure attachment point 84, or it can be left smooth to allow for quicker attachment and detachment.

Other forms of attachment points 84 also exist. There can be support arms extending out from the safety tether anchor 10 like the legs of a spider such that different items can be suspended about a periphery around the safety tether anchor 10. There can be a platform supported by the safety tether anchor 10 which can serve as a table or a place for setting items. The design, locations and function of attachment points 84 can vary significantly, and there are additional attachment points 84 not mentioned in this description.

The attachment points 84 can be used for storing or holding a very large variety of items. This includes such things as holding a weapon such as a bow or a gun. An umbrella can be inserted into a pipe 90, recess 92 or over a rod. Attachment points 84 can be used to hold a camera or a fanny pack. They can hold a cup or a cup holder. A pulley can be attached for hoisting items up to the safety tether anchor 10. Other items that can be held include cups, cup holders, binoculars, a light, a coat hangers supports for camouflage, a camera, or a rifle support. The rifle support can be as simple as a line hanging down from the safety tether anchor 10 with a ball or knot at the end of the line. The hunter 11 supports his hand with the rifle on the ball on the line, and then is able to move the rifle to aim. Tools used by workmen could also be stored for ready access as desired.

The pivot arm 70 folds back so the safety tether anchor 10 is relatively compact for travel. A bag can be included with pockets specially designed for specific items, such as an umbrella or the screw 26 and screw accessory 36. The pivot arm 70 and attachment point 84, combined with the pigtail 40 and support arm 50, provide a single device that serves several functions.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A safety tether anchor comprising:
a base including a strap notch;
a strap passing through the strap notch;
a support arm rigidly connected to the base where the support arm comprises a slide bracket angling outwardly and upwardly from the base, and where the support arm includes a distal end;
a pivot point at the support arm distal end;
a pivot arm having a pivot arm distal end, where the pivot arm is pivotally connected at the pivot point, and the pivot arm distal end includes at attachment point; and
a pigtail slidably connected to the slide bracket.

2. A safety tether anchor comprising:
a base; and
a support arm connected to the base wherein the support arm extends away from the base, the support arm further comprising a slide bracket for slidably connecting a tether to the support arm.

3. The safety tether anchor of claim 2 further comprising means for biasing the tether toward the base.

4. The safety tether anchor of claim 3 where the slide bracket angles upwardly and outwardly from the bases the safety tether anchor further comprising a pigtail connected to the slide bracket such that gravity biases the pigtail toward the base.

5. The safety tether anchor of claim 2 where the support arm includes a distal end and a pivot point at the distal end, the safety tether anchor further comprising a pivot arm pivotally connected to the support arm at the pivot point.

6. The safety tether anchor of claim 5 where the pivot arm further comprises a plurality of pivot arms pivotally connected together, the plurality of pivot arms including an inner pivot arm pivotally connected to the support arm at the pivot point.

7. The safety tether anchor of claim 6 where the pivot arm further comprises an outer pivot arm which pivots through a vertical position.

8. The safety tether anchor of claim 7 where the outer pivot arm includes a camera mount.

9. The safety tether anchor of claim 2 further comprising an attachment point.

10. The safety tether anchor of claim 2 where the base further comprises a strap notch, the safety tether anchor including a strap received in the strap notch.

11. The safety tether anchor of claim 2 where the base further comprises a screw receptacle, the safety tether anchor including a screw received in the screw receptacle.

12. A safety tether anchor comprising:
a base having a vertical orientation;
a support arm connected to the base and extending away from the base, where the support arm includes a pivot point; and
a pivot arm pivotally connected to the support arm through the pivot point such that the pivot arm pivots about the pivot point.

13. The safety tether anchor of claim 12 where the support arm further comprises a slide bracket, the safety tether anchor further comprising a pigtail slidably connected to the slide bracket.

14. The safety tether anchor of claim 13 where the pigtail is biased towards the base.

15. The safety tether anchor of claim 12 where the pivot arm includes an inner arm pivotally connected to the support arm and an outer arm pivotally connected to the inner arm.

16. The safety tether anchor of claim 12 where the base comprises a plate.

17. The safety tether anchor of claim 12 where the support arm further comprises a slide bracket.

18. The safety tether anchor of claim 17 where the slide bracket angles upwardly and outwardly from the base.

19. The safety tether anchor of claim 12 where the base further comprises a strap notch, the safety tether anchor further comprising a strap received in the strap notch.

20. The safety tether anchor of claim 12 where the base further comprises a screw receptacle, the safety tether anchor further comprising a screw received in the screw receptacle.

21. A safety tether anchor comprising:
means for attaching the safety tether anchor to an essentially vertical support; and
means for securing a tether to the safety tether anchor at a pigtail such that the pigtail can slide inwardly and outwardly from the essentially vertical support.
